(19) United States
(12) Patent Application Publication
(10) Pub. No.: US 2015/0306917 A1
(43) Pub. Date: Oct. 29, 2015

(54) TIRE WITH ROUNDED TREAD ELEMENTS

(71) Applicant: BRIDGESTONE AMERICAS TIRE OPERATIONS, LLC, Nashville, TN (US)

(72) Inventors: Sharon E. Reinhardt, Fairlawn, OH (US); Jacob R. Kidney, Wadsworth, OH (US)

(21) Appl. No.: 14/653,534

(22) PCT Filed: Dec. 17, 2013
(86) PCT No.: PCT/US2013/075553

§ 371 Date: Jun. 18, 2015

Related U.S. Application Data
(60) Provisional application No. 61/739,387, filed on Dec. 19, 2012.

(51) Int. Cl. B60C 11/12; B60C 11/00; B60C 5/00; B60C 11/04

(52) U.S. Cl. CPC B60C 11/12; B60C 11/04; B60C 11/0083; B60C 5/00

(57) ABSTRACT

A tire having a circumferential tread includes a plurality of tread elements. At least one tread element has a sipe disposed therein. The sipe is defined by a first sipe wall, a second sipe wall, and a curved sipe surface extending from the first sipe wall to a top surface of the at least one tread element.

### FIELD OF INVENTION

The present disclosure relates to a tire having a circumferential tread with a plurality of lugs or other tread elements disposed thereon. More particularly, the present disclosure relates to a tire having a circumferential tread with a plurality of lugs or other tread elements, with at least one having a rounded surface disposed between a wall and a top surface.

### BACKGROUND

Tires having circumferential treads with tread elements, such as lugs, blocks, or ribs, are known in the art. Such tread elements are often composed of planar surfaces. However, some tread elements are known to include curved surfaces. Some tread elements include sipes, or thin slits, to improve traction.

### SUMMARY OF THE INVENTION

In one embodiment, a tire includes a circumferential tread having a tread element disposed thereon. The tread element includes a front wall, a top surface, and a curved tread element surface extending from the front wall to the top surface. At least one sipe or slot is disposed in the tread element. The sipe is defined by at least two sipe walls, including a first sipe wall and a second sipe wall, and a curved sipe surface extending from the first sipe wall to the top surface of the tread element.

In another embodiment, a tire having a circumferential tread includes a plurality of tread elements. At least one tread element has a sipe or slot disposed therein. The sipe is defined by a first sipe wall, a second sipe wall, and a curved sipe surface extending from the first sipe wall to a top surface of the at least one tread element.

In yet another embodiment, a tire includes a circumferential tread having a plurality of lugs separated by grooves. At least one lug includes a first lug wall, a top surface, and a curved lug surface extending from the first lug wall to the top surface. The curved lug surface has a length that is no greater than 20% of a total length of the combined top surface and curved lug surface.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of one embodiment of a prior art tire having a circumferential tread;

FIG. 2 is a schematic drawing illustrating a profile of one embodiment of a tread element having a curved surface;

FIG. 3 is a schematic drawing illustrating a profile of one embodiment of a tread element having a pair of curved surfaces;

FIG. 4 is a schematic drawing illustrating a profile of one embodiment of a tread element having a sipe and a pair of curved surfaces;

FIG. 5 is a schematic drawing illustrating a profile of one embodiment of a tread element having a sipe and a plurality of curved surfaces;

FIG. 6 is a schematic drawing illustrating a profile of an alternative embodiment of a tread element having a sipe and a plurality of curved surfaces;

FIG. 7 is a schematic drawing illustrating a profile of another alternative embodiment of a tread element having a sipe and a plurality of curved surfaces; and

FIG. 8 is a perspective view of one embodiment of a tread element having a plurality of sipes and a plurality of curved surfaces.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Rib” or “ribs” define the circumferential extending strip or strips of rubber on the tread that is defined by at least one circumferential groove and either a second wide groove or a lateral edge of the tread.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

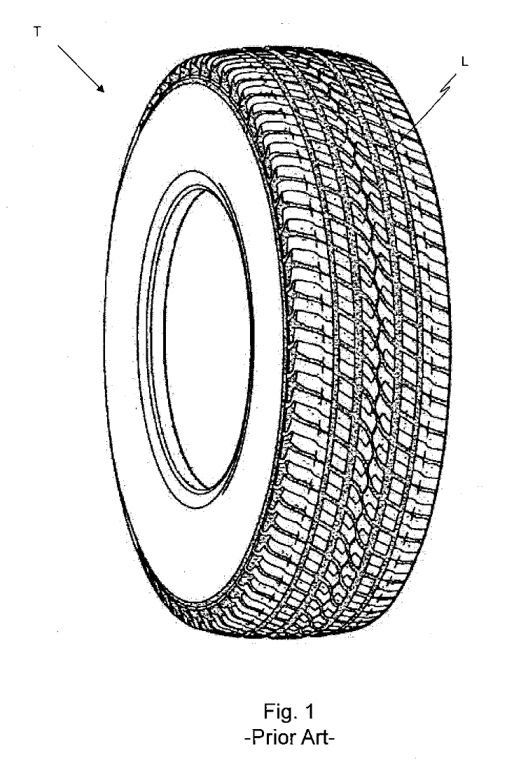

FIG. 1 illustrates a prior art tire T having a circumferential tread with a plurality of lugs L disposed thereon. In the illustrated embodiment, the lugs L are defined by a plurality of circumferential grooves and a plurality of transverse grooves or slots. The illustrated tire T is merely exemplary, and is intended to show that tread elements, such as the illustrated lugs L, may take any geometric shape. Other tires may have circumferential treads that include ribs, blocks, or other tread elements in addition to or instead of lugs. It should be understood that the various embodiments discussed below are not limited to any particular lug or any particular tire, but may instead be employed on any tread element of any tire.

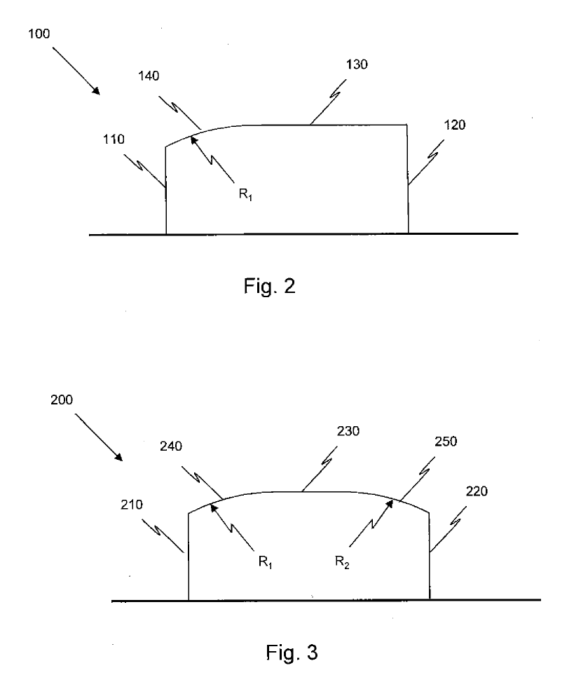

FIG. 2 is a schematic drawing illustrating a profile of an exemplary tread element 100 having a first wall 110, a second wall 120, and a top surface 130. It should be understood that this view of tread element 100 is from the side of a tire (i.e. parallel to the equatorial plane of the tire) and that in this orientation, the top surface 130 of the tread element 100 represents the top of the tire. In one embodiment, the tire is configured to rotate in a counter-clockwise direction. In such an embodiment, the first wall 110 is the leading wall or front wall. In an alternative embodiment, the tire is configured to rotate in a clockwise direction. In such an embodiment, the second wall 120 is the leading wall or front wall.

The tread element 100 includes a curved surface 140 extending from the first wall 110 to the top surface 130, while the second wall 120 forms an edge with the top surface 130. In the illustrated embodiment, the curved surface 140 is defined by a single radius R₁. In an alternative embodiment (not shown), the curved surface is defined by a plurality of radii.

In one embodiment, the curved surface 140 has a length that is no greater than 20% of the total length of the top surface 130 of the tread element 100. Additionally, the curved surface 140 has a length that is substantially greater than its height. In one known embodiment, the curved surface has a height of 0.015 inches (0.38 mm), a length of 0.058 inches (1.47 mm), and is defined by a radius of 0.126 inches (3.20 mm). In another known embodiment, the curved surface has a height of 0.025 inches (0.64 mm), a length of 0.096 inches (2.44 mm), and is defined by a radius of 0.283 inches (7.19 mm). It should be understood that these dimensions may be scaled up or down. It should be further understood that the dimensions may be changed entirely. For example, in an alternative embodiment, the height of the curved surface may be greater than its length.

As one of ordinary skill in the art would understand, when a brake force is applied to a tire, tread elements begin to shear. As a tread element shears, the normal force shifts away from the center of the element, causing a moment. Reaction forces balance this shift in force distribution, thereby changing the contact pressure distribution. In some instances, the use of a curved surface on the tread element may result in more uniform contact pressure distribution, and reduce involution—a phenomenon in which a front edge of a tread element curls under the tread element.

FIG. 3 is a schematic drawing illustrating a profile of an alternative embodiment of a tread element 200 having a first wall 210, a second wall 220, and a top surface 230. It should be understood that this view of tread element 200 is from the side of a tire (i.e. parallel to the equatorial plane of the tire). The tread element 200 includes a first curved surface 240 extending from the first wall 210 to the top surface 230 and a second curved surface 250 extending from the second wall 220 to the top surface 230. In the illustrated embodiment, the first curved surface 240 is defined by a single first radius R₁ and the second curved surface 250 is defined by a single second radius R₂. In the illustrated embodiment, the first radius R₁ is equal to the second radius R₂. In an alternative embodiment (not shown), the first radius R₁ is different from the second radius R₂. In another alternative embodiment (not shown), one or both of the first and second curved surfaces is defined by a plurality of radii.

In one embodiment, each of the first and second curved surfaces 240, 250 has a length that is no greater than 20% of the total length of the top surface 230 of the tread element 200. Additionally, each of the first and second curved surfaces 240, 250 has a length that is substantially greater than a height. The first and second curved surfaces 240, 250 may have the same dimensions discussed above with respect to the curved surface 140 of the tread element 100 of FIG. 1. However, it should be understood that the dimensions may be scaled up or down. It should be further understood that the dimensions may be changed entirely. For example, in an alternative embodiment, the height of one or both of the curved surfaces may be greater than a length.

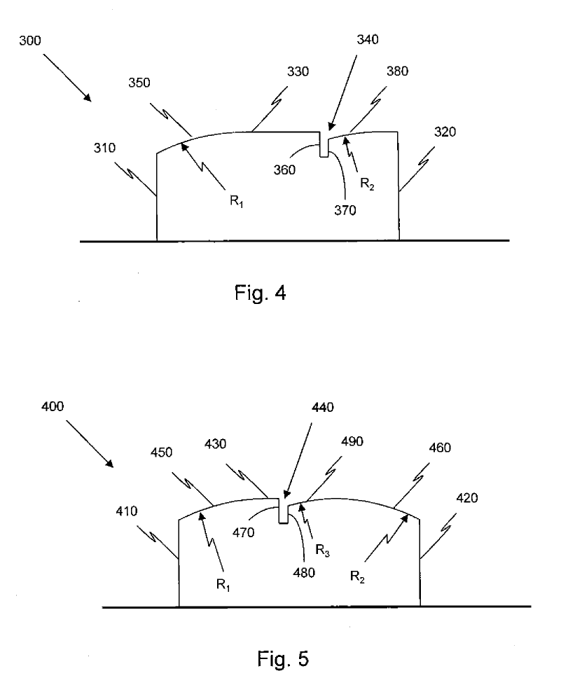

FIG. 4 is a schematic drawing illustrating a profile of another alternative embodiment of a tread element 300 having a first tread element wall 310, a second tread element wall 320, and a top surface 330 with a sipe 340 disposed therein. It should be understood that this view of tread element 300 is from the side of a tire (i.e. parallel to the equatorial plane of the tire).

The tread element 300 also includes a curved tread element surface 350 extending from the first tread element wall 310 to the top surface 330, while the second wall 320 forms an edge with the top surface 330. The sipe 340 is defined by a first sipe wall 360, a second sipe wall 370, and a curved sipe surface 380 extending from the second sipe wall 370 to the top surface 330. The first sipe wall 360 forms an edge with the top surface 330. The first sipe wall 360 is the sipe wall closest to the first tread element wall 310 and the second sipe wall 370 is the sipe wall closest to the second tread element wall 320. Accordingly, the first sipe wall 360 may be described as being between the first tread element wall 310 and the second sipe wall 370.

In the illustrated embodiment, the curved tread element surface 350 is defined by a single first radius R₁ and the curved sipe surface 380 is defined by a single second radius R₂. In the illustrated embodiment, the first radius R₁ is equal to the second radius R₂. In an alternative embodiment (not shown), the first radius R₁ is different from the second radius R₂. In another alternative embodiment (not shown), one or both of the first and second curved surfaces is defined by a plurality of radii.

In one embodiment, each of the curved tread element surface 350 and the curved sipe surface 380 has a length that is no greater than 20% of the total length of the top surface 330 of the tread element 300. Additionally, each of the curved tread element surface 350 and the curved sipe surface 380 has a length that is substantially greater than a height. The curved tread element surface 350 and the curved sipe surface 380 may have the same dimensions discussed above with respect to the curved surface 140 of the tread element 100 of FIG. 1. However, it should be understood that the dimensions may be scaled up or down. It should be further understood that the dimensions may be changed entirely. For example, in an alternative embodiment, the height of one or both of the curved surfaces may be greater than a length.

FIG. 5 is a schematic drawing illustrating a profile of yet another alternative embodiment of a tread element 400 having a first tread element wall 410, a second tread element wall 420, and a top surface 430 with a sipe 440 disposed therein. It should be understood that this view of tread element 400 is from the side of a tire (i.e. parallel to the equatorial plane of the tire).

The tread element 400 also includes a first curved tread element surface 450 extending from the first tread element wall 410 to the top surface 430, and a second curved tread element surface 460 extending from the second tread element wall 420 to the top surface 430. The sipe 440 is defined by a first sipe wall 470, a second sipe wall 480, and a curved sipe surface 490 extending from the second sipe wall 480 to the top surface 430. The first sipe wall 470 forms an edge with the top surface 430. The first sipe wall 470 is the sipe wall closest to the first tread element wall 410 and the second sipe wall 480 is the sipe wall closest to the second tread element wall 420. Accordingly, the first sipe wall 470 may be described as being between the first tread element wall 410 and the second sipe wall 480.

In the illustrated embodiment, the first curved tread element surface 450 is defined by a single first radius R₁, the second curved tread element surface 460 is defined by a single second radius R₂, and the curved sipe surface 490 is defined by a single third radius R₃. In the illustrated embodiment, the first radius R₁ is equal to the second radius R₂ and to the third radius R₃. In an alternative embodiment (not shown), one or more of the first radius R₁, the second radius R₂, and the third radius R₃ are different. In another alternative embodiment (not shown), one or more of the first, second, and third curved surfaces is defined by a plurality of radii.

In one embodiment, each of the curved tread element surfaces 450, 460 and the curved sipe surface 490 has a length that is no greater than 20% of the total length of the top surface 430 of the tread element 400. Additionally, each of the curved tread element surfaces 450, 460 and the curved sipe surface 490 has a length that is substantially greater than a height. The curved tread element surfaces 450, 460 and the curved sipe surface 490 may have the same dimensions discussed above with respect to the curved surface 140 of the tread element 100 of FIG. 1. However, it should be understood that the dimensions may be scaled up or down. It should be further understood that the dimensions may be changed entirely. For example, in an alternative embodiment, the height of one or more of the curved surfaces may be greater than a length.

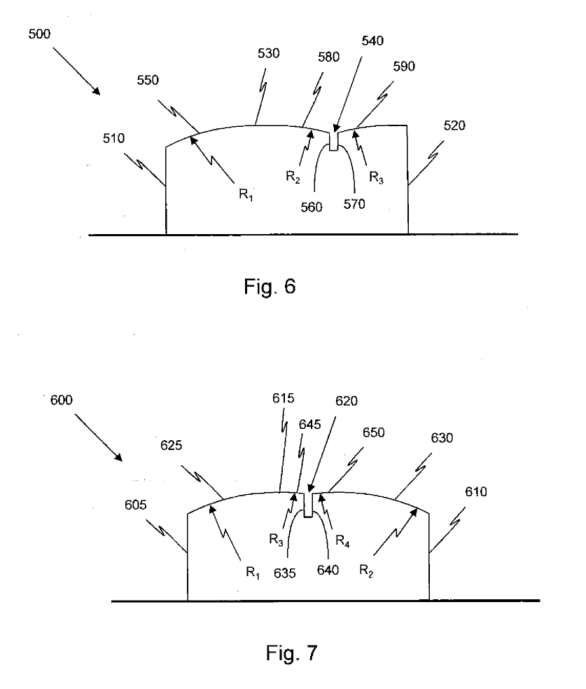

FIG. 6 is a schematic drawing illustrating a profile of still another alternative embodiment of a tread element 500 having a first tread element wall 510, a second tread element wall 520, and a top surface 530 with a sipe 540 disposed therein. It should be understood that this view of tread element 500 is from the side of a tire (i.e. parallel to the equatorial plane of the tire).

The tread element 500 also includes a curved tread element surface 550 extending from the first tread element wall 510 to the top surface 530, while the second tread element wall 520 forms an edge with the top surface 530. The sipe 540 is defined by a first sipe wall 560, a second sipe wall 570, a first curved sipe surface 580 extending from the first sipe wall 560 to the top surface 530, and a second curved sipe surface 590 extending from the second sipe wall 570 to the top surface 530. The first sipe wall 560 is the sipe wall closest to the first tread element wall 510 and the second sipe wall 570 is the sipe wall closest to the second tread element wall 520. Accordingly, the first sipe wall 560 may be described as being between the first tread element wall 510 and the second sipe wall 570.

In the illustrated embodiment, the curved tread element surface 550 is defined by a single first radius R₁, the first curved sipe surface 580 is defined by a single second radius R₂, and the second curved sipe surface 590 is defined by a single third radius R₃. In the illustrated embodiment, the first radius R₁ is equal to the second radius R₂ and to the third radius R₃. In an alternative embodiment (not shown), one or more of the first radius R₁, the second radius R₂, and the third radius R₃ are different. In another alternative embodiment (not shown), one or more of the first, second, and third curved surfaces is defined by a plurality of radii.

In one embodiment, each of the curved tread element surface 550 and the curved sipe surfaces 580, 590 has a length that is no greater than 20% of the total length of the top surface 530 of the tread element 500. Additionally, each of the curved tread element surface 550 and the curved sipe surfaces 580, 590 has a length that is substantially greater than a height. The curved tread element surface 550 and the curved sipe surfaces 580, 590 may have the same dimensions discussed above with respect to the curved surface 140 of the tread element 100 of FIG. 1. However, it should be understood that the dimensions may be scaled up or down. It should be further understood that the dimensions may be changed entirely. For example, in an alternative embodiment, the height of one or more of the curved surfaces may be greater than a length.

FIG. 7 is a schematic drawing illustrating a profile of still another alternative embodiment of a tread element 600 having a first tread element wall 605, a second tread element wall 610, and a top surface 615 with a sipe 620 disposed therein. It should be understood that this view of tread element 600 is from the side of a tire (i.e. parallel to the equatorial plane of the tire).

The tread element 600 also includes a first curved tread element surface 625 extending from the first tread element wall 605 to the top surface 615 and a second curved tread surface 630 extending from the second tread element wall 610 to the top surface 615. The sipe 620 is defined by a first sipe wall 635, a second sipe wall 640, a first curved sipe surface 645 extending from the first sipe wall 635 to the top surface 615, and a second curved sipe surface 650 extending from the second sipe wall 640 to the top surface 615. The first sipe wall 635 is the sipe wall closest to the first tread element wall 605 and the second sipe wall 640 is the sipe wall closest to the second tread element wall 610. Accordingly, the first sipe wall 635 may be described as being between the first tread element wall 605 and the second sipe wall 640.

In the illustrated embodiment, the first curved tread element surface 625 is defined by a single first radius R₁, the second curved tread element surface 630 is defined by a single second radius R₂, the first curved sipe surface 645 is defined by a single third radius R₃, and the second curved sipe surface 650 is defined by a single fourth radius R₄. In the illustrated embodiment, the first radius R₁ is equal to the second radius R₂, the third radius R₃, and the fourth radius R₄. In an alternative embodiment (not shown), one or more of the first radius R₁, the second radius R₂, the third radius R₃, and the fourth radius R₄ are different. In another alternative embodiment (not shown), one or more of the first, second, third, and fourth curved surfaces is defined by a plurality of radii.

In one embodiment, each of the curved tread element surfaces 625, 630 and the curved sipe surfaces 645, 650 has a length that is no greater than 20% of the total length of the top surface 615 of the tread element 600. Additionally, each of the curved tread element surfaces 625, 630 and the curved sipe surfaces 645, 650 has a length that is substantially greater than a height. The curved tread element surfaces 625, 630 and the curved sipe surfaces 645, 650 may have the same dimensions discussed above with respect to the curved surface 140 of the tread element 100 of FIG. 1. However, it should be understood that the dimensions may be scaled up or down. It should be further understood that the dimensions may be changed entirely. For example, in an alternative embodiment, the height of one or more of the curved surfaces may be greater than a length.

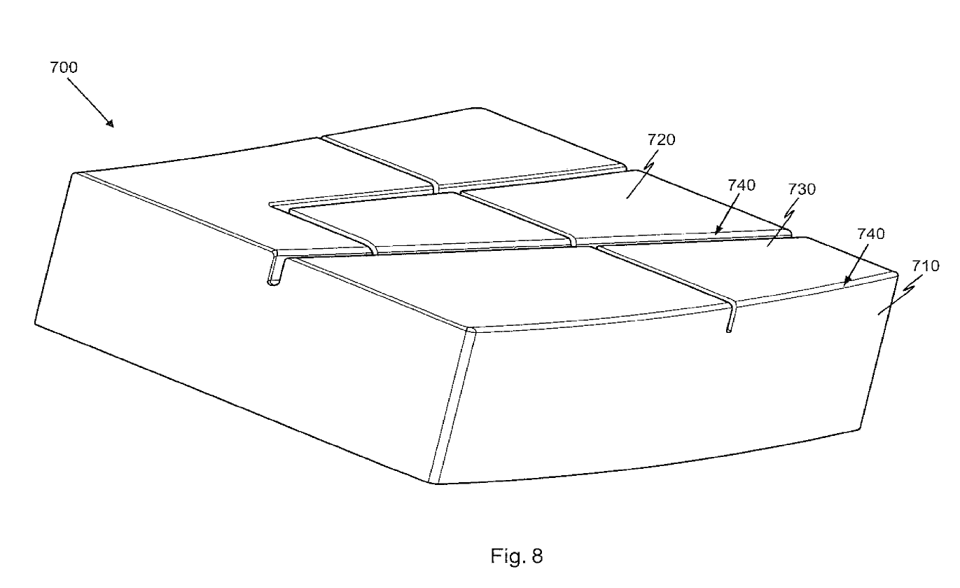

FIG. 8 is a perspective view of yet another alternative embodiment of a tread element 700. The tread element 700 includes a first wall 710, a second wall opposite the first wall (not shown in this view), and a top surface 720. The tread element 700 has a plurality of sipes 730 and a plurality of curved surfaces 740 extending from the tread element walls and the sipe walls.

It should be understood that the tread element 700 is merely exemplary. FIG. 8 illustrates that some sipes 730 may be disposed at an acute angle with respect to a tread element wall, while other sipes are parallel or perpendicular to a tread element wall.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. A tire comprising:
a circumferential tread having a tread element disposed thereon, wherein the tread element includes a front wall, a top surface, and a curved tread element surface extending from the front wall to the top surface; and
at least one sipe disposed in the tread element, wherein the sipe is defined by at least two sipe walls, including a first sipe wall and a second sipe wall, and a curved sipe surface extending from the first sipe wall to the top surface of the tread element.

17. The tire of claim 16, where the second sipe wall is disposed between the first sipe wall and the front wall of the tread element.

18. The tire of claim 16, where the tread element further includes a rear wall opposite the front wall.

19. The tire of claim 18, where the tread element further includes a second curved tread element surface disposed between the rear wall of the tread element and the top surface of the tread element.

20. The tire of claim 16, where the curved tread element surface is defined by a single first radius.

21. The tire of claim 20, wherein the curved sipe surface is defined by a single second radius.

22. The tire of claim 21, wherein the first radius is different from the second radius.

23. The tire of claim 16, where the curved tread element surface has a height and a length that is substantially greater than the height.

24. The tire of claim 16, wherein the curved tread element surface has a length that is no greater than 20% of a total length of the combined top surface and curved tread element surface.

25. A tire having a circumferential tread, the tire comprising:
a plurality of tread elements, including at least one tread element having a sipe disposed therein,
wherein the sipe is defined by a first sipe wall, a second sipe wall, and a curved sipe surface extending from the first sipe wall to a top surface of the at least one tread element.

26. The tire of claim 25, wherein the at least one tread element includes a tread element wall, and a curved tread element surface extending from the tread element wall to the top surface of the at least one tread element, wherein the curved tread element has a length that is no greater than 20% of a total length of the combined top surface, curved tread element surface, and curved sipe surface.

27. The tire of claim 25, wherein the sipe is further defined by a second curved sipe surface extending from the second sipe wall to the top surface of the at least one tread element.

28. The tire of claim 25, wherein the second sipe wall forms an edge with the top surface of the at least one tread element.

29. The tire of claim 25, wherein the curved sipe surface is defined by a single radius.

30. The tire of claim 25, wherein the curved sipe surface has a height and a length that is substantially greater than the height.

31. A tire comprising:
a circumferential tread having a plurality of lugs separated by grooves, wherein at least one lug includes a first lug wall, a top surface, and a curved lug surface extending from the first lug wall to the top surface, wherein the curved lug surface has a length that is no greater than 20% of a total length of the combined top surface and curved lug surface.

32. The tire of claim 31, wherein the curved lug surface is defined by a single first radius.

33. The tire of claim 32, wherein the lug further includes a second lug wall opposite the first lug wall and a second curved lug surface extending from the second lug wall to the top surface.

34. The tire of claim 33, wherein the second curved lug surface is defined by a single second radius equal to the first radius.

35. The tire of claim 31, where the curved lug surface has a height and a length that is substantially greater than the height.
